(19) United States
(12) Patent Application Publication
(10) Pub. No.: US 2010/0308142 A1
(43) Pub. Date: Dec. 9, 2010

(54) MAGNETIC SWITCH FOR FOOD PROCESSOR

(76) Inventors: CHARLES Z. KRASZNAI, BRIDGEPORT, CT (US); ZHI HE HU, SHENZHEN CITY (CN)

Correspondence Address: Lawrence Cruz;Conair Corporation, One Cummings Point Road, STAMFORD, CT, 06902, US

(21) Appl. No.: 12/480,151

(22) Filed: Jun. 8, 2009

(51) Int. Cl. B02C 23/00

(52) U.S. Cl. 241/36

(57) ABSTRACT

A magnetic switch for, inter alia, a food processor, wherein, when a cover is locked on a bowl, which in turn is locked to a base, magnets are brought towards a magnetically controlled working contact connected in series in the supply circuit of a motor.

### FIELD OF THE INVENTION

The invention relates to a magnetic switch for use more particularly though not exclusively for a food processor.

### BACKGROUND OF THE INVENTION

Food processors conventionally comprise a base enclosing an electric motor having a shaft on which various tools such as knives or scrapers can be mounted. The drive shaft projects into a bowl adapted to enclose the tools and the products which have been or are being processed. In some cases the bowl is removably mounted on the base for ease in cleaning. The bowl is closed by a removable cover, the main purpose of which is to prevent material from being thrown out of the bowl. The devices have to be fitted with a safety means because they can be very dangerous as tools are driven at high speed in the bowl and any contact with a rotating tool may result in serious injury.

The motor must be stopped either when the bowl is not properly fitted on the base or when the bowl is properly fitted on the base but the cover is not locked on the bowl. The idea, of course, is to prevent any contact with the rotating tool. This result can be obtained by disposing a working contact in the base, the contact being connected in series in the motor supply circuit and being open or closed depending on whether the bowl and cover are properly positioned, i.e., the cover is locked to the bowl and the bowl is locked to the base.

One solution has already been proposed in U.S. Pat. No. 4,741,482 to Coggiola et al. (“the '482 patent”), which also describes other solutions prior to the '482 patent. The '482 patent relates to a magnetic safety device for a food processor comprising a base from which a drive shaft extends and is adapted to receive various tools, the processor also comprising a first element detachably mounted on the base and bearing means for securing to the base so as to hold it in a given position, a second element bearing means for locking to the first element in a given position, and a duct extending along a generatrix of the first element so that in the operating position a substantially punctiform region of the base is geometrically in line with the axis of the duct and a point on the second element, characterized in that at least one contact is disposed in the base and at least one permanent magnet is secured to one of the two elements.

However, the device cannot be considered perfectly because the contact can be actuated by placing a magnet inserting a pointed object into the orifice in the base when the bowl is not in position, thus rotating the drive shaft. When the bowl is in position, it is also possible to start the motor by pressing the top end of the pusher. Finally, there may be difficulties in cleaning and maintaining the pusher, which is pushed upwards by a spring.

The aim of the invention is to obviate the aforementioned disadvantages and construct a safety device which is more reliable.

### SUMMARY OF THE INVENTION

The present invention relates to a magnetic switch for, inter alia, a food processor comprising a base from which a tower and a drive shaft extend. Within inside of the tower, near its top, are disposed four magnets that control an electrical contact in the base, which contact either enables or disables a motor disposed in the base. The drive shaft is adapted to receive various tools that rotate to process various food products. The food processor also comprises a bowl detachably mounted on the base, said bowl having means for securing to the base so as to hold it in a given position, and a bowl cover having a chute. The bowl cover also comprises means for locking to the bowl and four magnets, which magnets are aligned with the four magnets disposed within the top of the tower extending from the base of the food processor. A pusher is used to push products down the chute without any possible contact between a hand and a rotating tool. The pusher comprises an actuator that push down the magnets of the bowl cover, thus activating the magnets disposed in the tower. Once the tower magnets are activated, the electrical contact in the base enables the motor and allows the food processor to operate.

The '482 patent describes a food processor comprising a bowl and a bowl cover, the bowl having a duct extending along a generatrix of the bowl. The duct is adapted to receive a pusher, which, when both the bowl and the bowl cover are in proper position, enables an actuating means to engage a hole in the base and act on a mechanical contact within the base. The bowl further comprises a magnet that actuates a magnetically-controlled contact within the base when the bowl is properly positioned. The mechanical and magnetically-controlled contacts are connected in series in the supply circuit of the motor. Thus, the tool cannot be driven by the motor unless the bowl is properly mounted on the base and the bowl cover is properly mounted on the bowl. The safety feature of the prior patent, however, can be defeated by inserting a pointed object in the hole of the base to actuate the mechanical contact and concurrently placing a magnet above the magnetically controlled contact.

The present invention, in contrast, does not require a hole in the base to actuate a contact within it to supply power to the motor. Instead, the present invention utilizes, in the bowl cover, four magnets, the magnetic pole arrangement for which alternates. The proper polarity arrangement of the magnets repel the four magnets in the tower, which then actuates the magnetically-controlled contact in the base, which then enables the motor. The safety feature thus requires not only that the bowl and bowl cover are properly in place but also that the pusher is also in place. Further, the safety device cannot be inactivated unless by a person in possession of four magnets in proper polarity arrangement, which greatly reduces the risk of improperly starting the motor.

Other features and advantages of the invention will be clear from the following description of preferred embodiments of the invention. It is to be understood that the foregoing general description and the following detailed description are exemplary and explanatory but are not to be restrictive of the invention. The accompanying drawings, which are incorporated in and constitute a part of this invention, illustrate embodiments of the invention and, together with the description, serve to explain the principles of the invention in general terms. Like numerals refer to like parts throughout the disclosure.

### BRIEF DESCRIPTION OF THE INVENTION

The foregoing aspects and other features of the present invention are explained in the following description, taken in connection with the accompanying drawings, wherein:

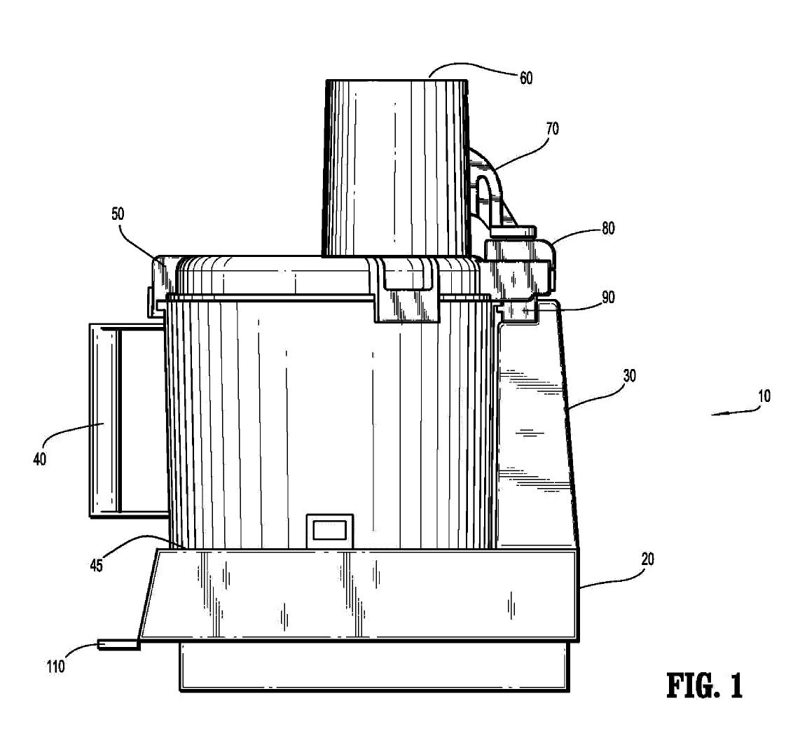

FIG. 1 is a diagrammatic view of a food processor comprising a magnetic safety device according to the invention;

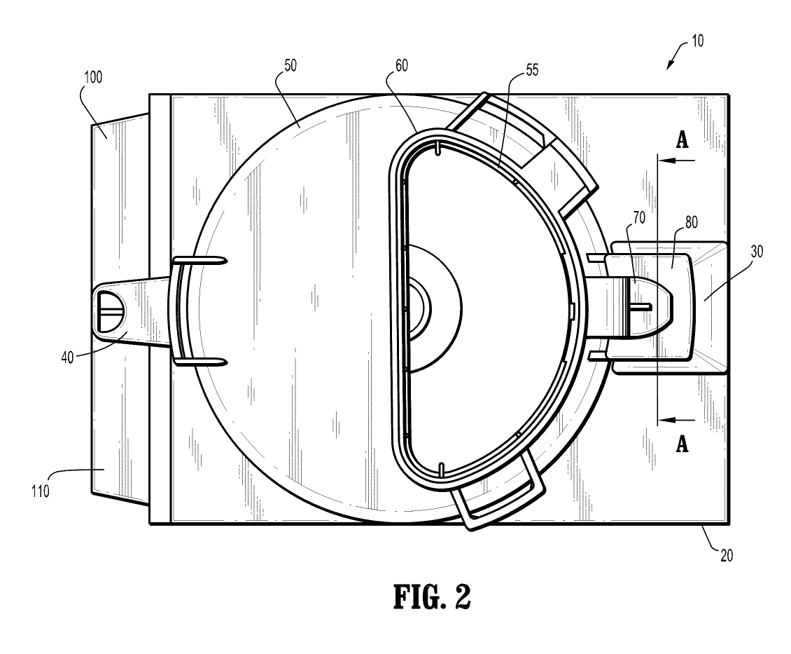

FIG. 2 is a top view of the food processor of FIG. 1;

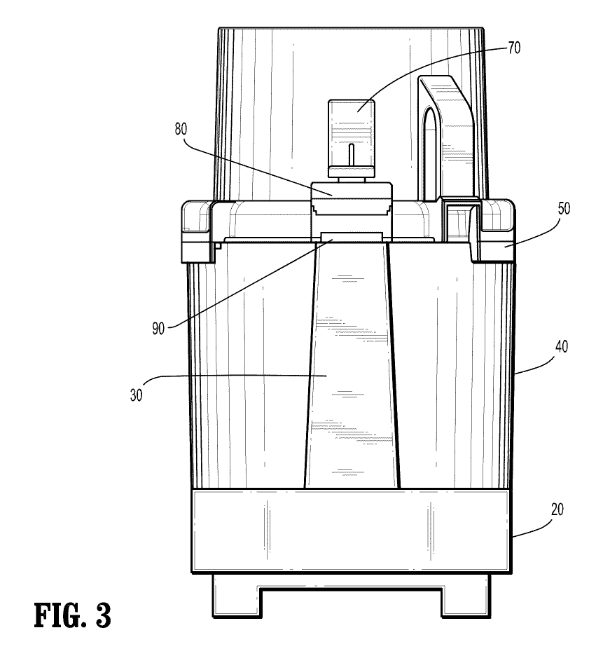

FIG. 3 is a right side view of the food processor of FIG. 1;

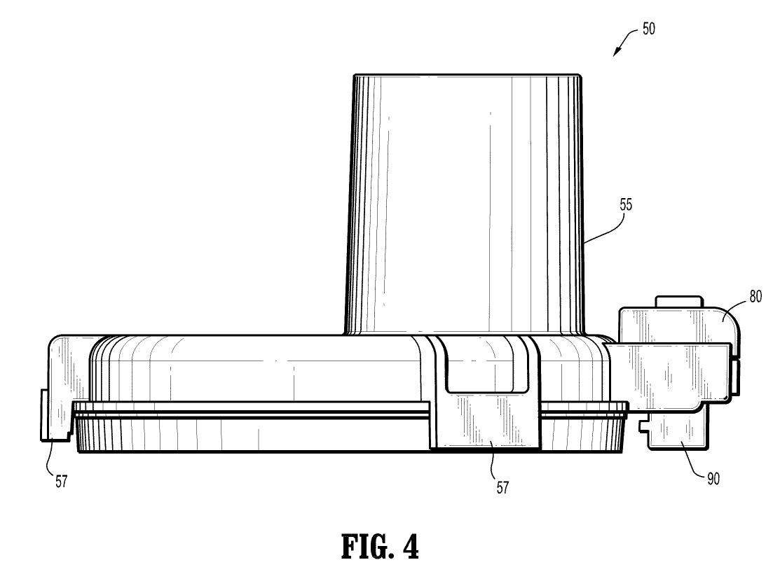

FIG. 4 depicts a bowl cover comprising a magnetic safety device according to the invention;

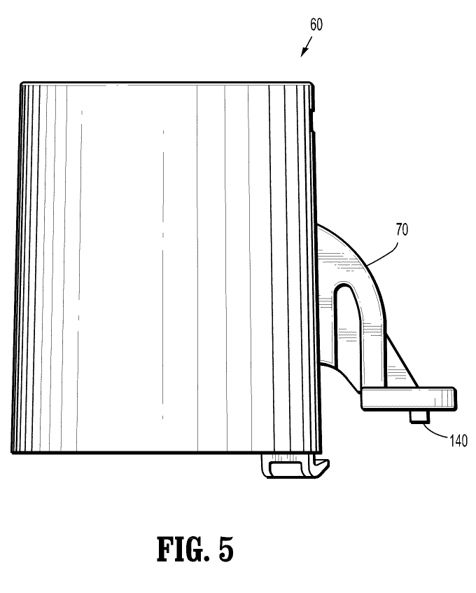

FIG. 5 depicts a pusher used in conjunction with a food processor to actuate a magnetic safety device according to the invention;

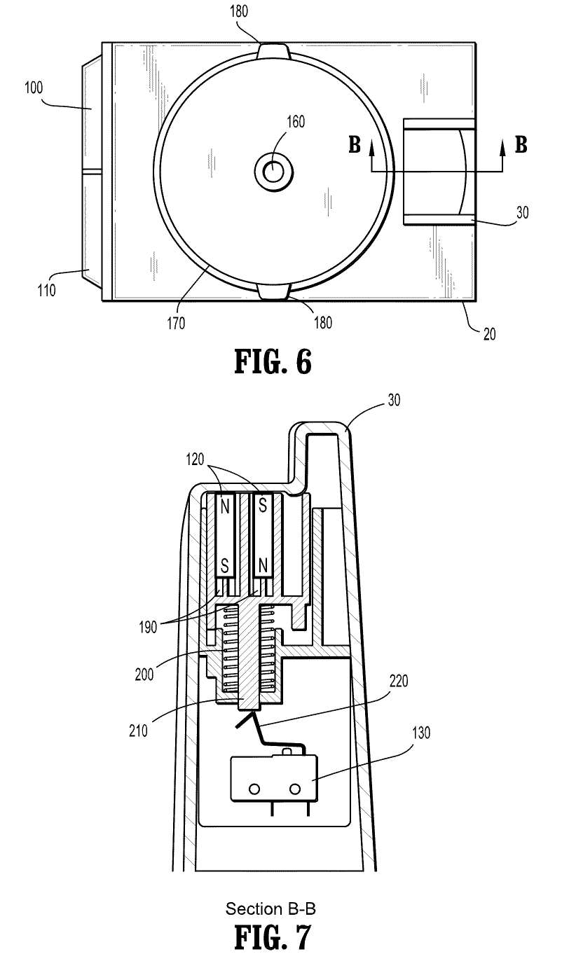

FIG. 6 depicts a base of the food processor of FIG. 1;

FIG. 7 is a sectional view of a tower of the base depicted in FIG. 6, wherein a magnetic safety device according to the invention is not actuated;

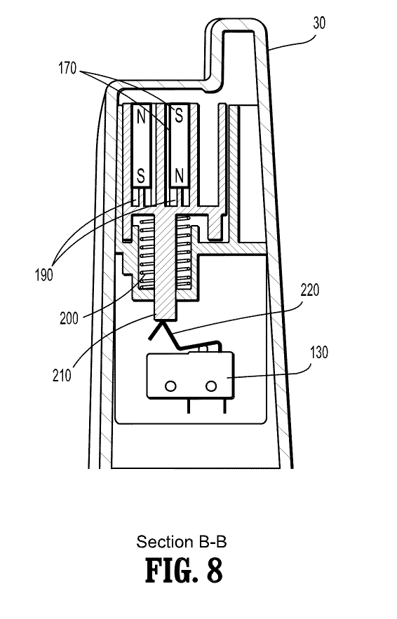

FIG. 8 is a sectional view of a tower of the base depicted in FIG. 6, wherein a magnetic safety device according to the invention is actuated;

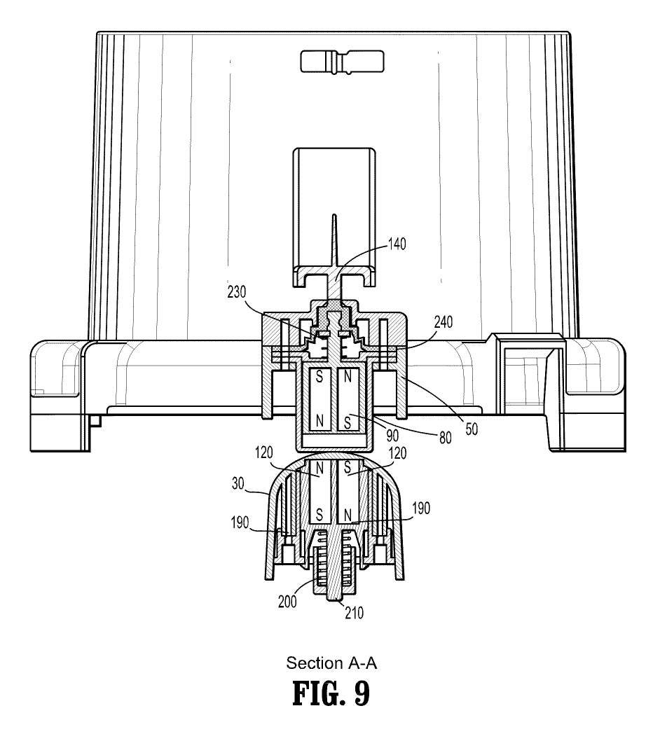

FIG. 9 is a sectional view of a magnetic safety device according to the invention; and

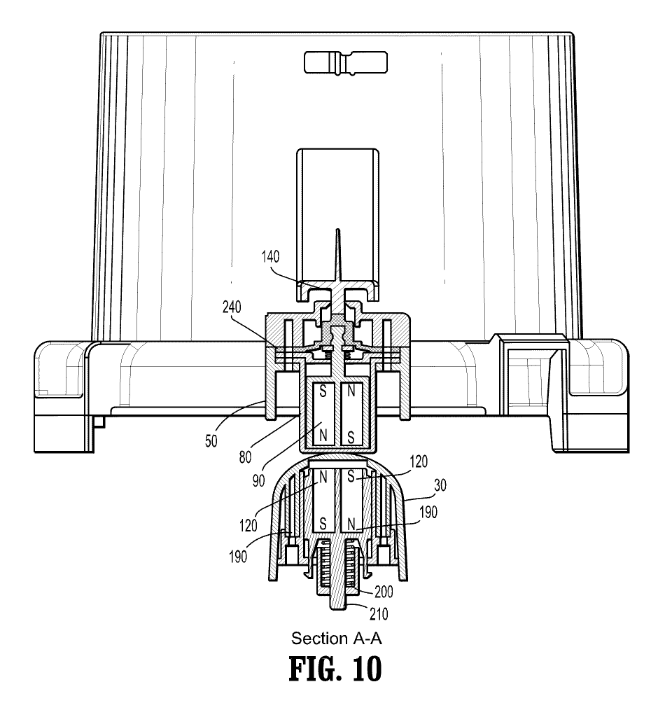

FIG. 10 is a sectional view of a magnetic safety device according to the invention.

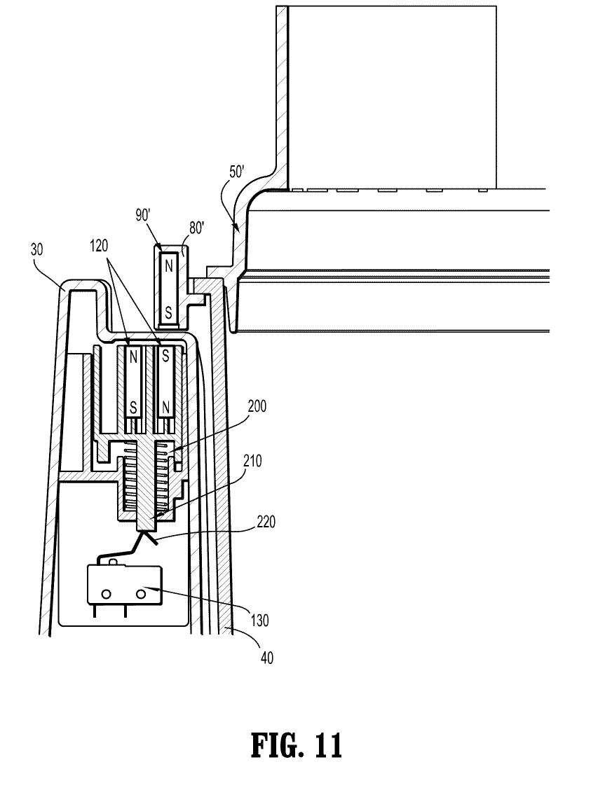

FIG. 11 is a sectional view of a magnetic safety device according to the invention.

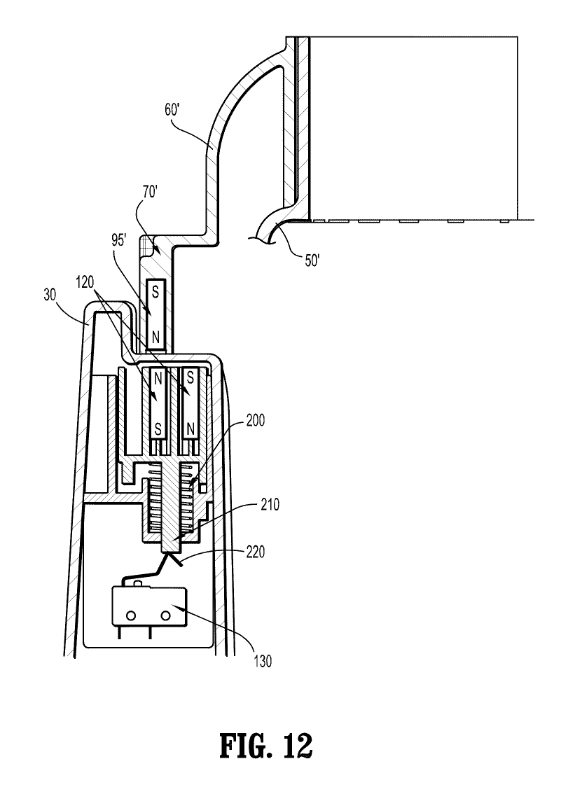

FIG. 12 is a sectional view of a magnetic safety device according to the invention.

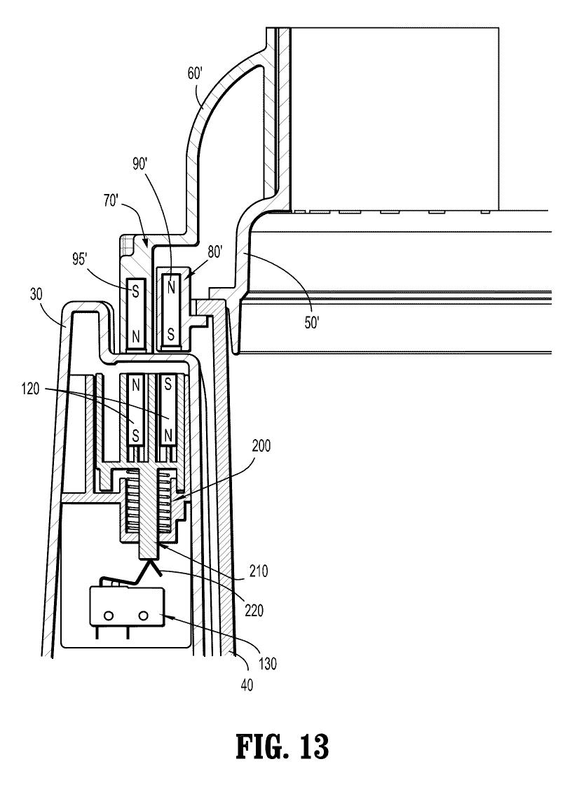

FIG. 13 is a sectional view of a magnetic safety device according to the invention.

### DETAILED DESCRIPTION OF THE INVENTION

Reference will now be made in detail to embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, below, left, and right may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

Referring to the drawings, FIGS. 1-3, in particular, food processor 10 comprises a base 20 from which a tower 30 and a drive shaft 160 (FIG. 6) extend. Base 20, as known in the art, encloses an electric motor (not shown) mounted so that its axis is vertical and extends through a top wall of base 20. Alternatively, the vertical output shaft (not shown) of a speed reduction gear can extend through the top wall of the base and its input shaft can be coupled to the motor drive shaft 160, which can be disposed parallel to a bowl 40, which is detachably mounted on base 20 and has means for securing to base 20 so as to hold it in a given position, generally known in the art.

Bowl 40 is generally cylindrical in shape and has a bottom 45 formed with an aperture (not shown) for the end of the drive shaft 160 or the output shaft of a speed reduction gear, when bowl 40 is mounted on base 20. As known in the art, a tool comprising radial knives (not shown) can be coupled by any appropriate means to the end of the drive shaft 160 in bowl 40 mounted on base 20.

As shown in FIGS. 1-4, food processor 10 further comprises a bowl cover 50 that is detachably mounted on bowl 40 and has means for securing to bowl 40 such as flanges 150, as known in the art. Bowl cover 50 further has a chute 55 and four magnets 90, which are housed in magnet housing 80. As discussed more fully below, and as shown in FIGS. 9 and 10, when bowl 40 and bowl cover 50 properly are in position, magnets 90 are aligned with the four magnets 120 disposed within the top of tower 30 extending from base 20 of food processor 10.

FIG. 5 depicts a pusher 60 that is used to push products down chute 55 of bowl cover 50 without any possible contact between a hand and a rotating tool. Pusher 60 comprises an actuator arm 70 having an actuation finger 140 that pushes down the magnets 90 of bowl cover 50, thus activating magnets 120 disposed in tower 30.

FIG. 6 is a top view of the base 20 without either bowl 40 or bowl cover 50 thereon. In the particular embodiment depicted in FIG. 6, there is shown tower 30, on-switch 100, pulse/off-switch 110, and raised surface 170. Bowl 40 rests on raised surface 170 and stops 180 are used to properly position bowl 40 on base 20.

As can be seen in FIGS. 7 and 8, within the top of tower 30 are disposed four magnets 120 that control an electrical contact 130, which is connected in series in the motor supply circuit (not shown), is known in the art and is an on-off standard microswitch. Magnets 120 reside in magnet housing 190 having a rod 210. Magnet housing 190 rests on spring 200 and moves vertically toward or away from switch 220. FIG. 7 depicts spring 200 in an uncompressed state, whereas FIG. 8 depicts spring 200 in a compressed state. As depicted in FIG. 7, when spring 200 is uncompressed, electrical contact 130 is not actuated. When contact 130 is not actuated, the supply circuit for the motor is open and the motor cannot start. However, when spring 200 is sufficiently compressed, rod 130 makes contact with switch 220, thereby actuating contact 130. When contact 130 is actuated, the supply circuit for the motor is closed and the motor can be started by, e.g., pressing on-switch 100 or pulse/off-switch 110.

FIGS. 9 and 10 depict a cross section of housing 80, which comprise four magnets 90. Housing 80 is kept in the position depicted in FIG. 9 by means of sealing rubber 240. When bowl 40 is properly mounted on base 20 and bowl cover 50 is properly mounted on bowl 40, magnets 90 are in alignment with magnets 120 in tower 30. Although magnets 120 are aligned with magnets 90, the air gap is sufficiently great so as to prevent repulsion of like magnetic poles. However, when pusher 60 is fully pushed down chute 55, finger 140 pushes on the top of magnet housing 80 causing the air gap between magnets 120 and 90 to cause repulsion of like magnetic poles, causing magnet housing 190 in tower 30 to move toward switch 220 of contact 130. At full repulsion of magnets 120, switch 220 of contact 130 closes the supply circuit for the motor, thus allowing the motor to be started.

Thus the tools on drive shaft 160 cannot be driven in rotation unless (a) bowl 40 is mounted on base 20 in the correct position, (b) bowl cover 50 is mounted on bowl 40 in the correct position for magnets 90 to be aligned over magnets 120 and (c) pusher 60 is fully pushed down chute 55 so as to push magnet housing 80 toward magnets 120 so as to actuate switch 220 of contact 130. If bowl 40 is not properly mounted on base 20, bowl cover 50 cannot be properly in place so as to have magnets 120 and 90 properly aligned. In addition, even if bowl 40 and cover 50 are properly in position, if pusher 60 is not pushed down chute 55, the supply circuit is open and the motor cannot start.

In order to reduce the air gaps, magnets 90 come in contact with a very thin bottom wall of magnet housing 80. Likewise, magnets 120 come in contact with a very thin top wall of magnet housing 190.

Another embodiment of the invention is depicted in FIGS. 11-13. Bowl cover 50′ comprises magnet housing 80′, which houses two magnets 90′. Pusher 60′, which is used to push products down a chute (not shown) of bowl cover 50′, comprises an arm 70′ that houses two magnets 95′. As shown in FIG. 13, when bowl 40 and bowl cover 50′ properly are in position, magnets 90′ are aligned with two of the four magnets 120 disposed within the top of tower 30 extending from base 20 of food processor 10. Moreover, as shown in FIG. 13, when pusher 60′ is pressed fully down the chute (not shown) of bowl cover 50′, two magnets 95′ are aligned with the other two of the four magnets 120 disposed within the top of tower 30. As depicted in FIG. 13, magnets 120 are repulsed by magnets 90′ and 95′, causing rod 210 to trigger switch 220 and thus closing contact 130 and the supply circuit to the motor.

As shown in FIG. 11, if only bowl cover 50′ is properly in place over two of magnets 120, i.e., without pusher 60′, spring 200 is compressed only slightly but not enough to activate switch 220. Likewise, as shown in FIG. 12, if only pusher 60′ is in place without bowl cover 50′, magnets 95′ may be aligned with two of magnets 120 and spring 200 is compressed only slightly but not enough to activate switch 220. Thus the tools on drive shaft 160 cannot be driven in rotation unless (a) bowl 40 is mounted on base 20 in the correct position, (b) bowl cover 50′ is mounted on bowl 40 in the correct position for magnets 90′ to be aligned over two magnets of four magnets 120 and (c) pusher 60 is fully pushed down the chute (not shown) of bowl cover 50′ which causes alignment of magnets 95′ to be aligned over the other two magnets of magnets 120. If bowl 40 is not properly mounted on base 20, bowl cover 50′ cannot be properly in place so as to have magnets 90′ properly aligned over two of magnets 120. In addition, even if bowl 40 and bowl cover 50′ are properly in position, if pusher 60′ is not pushed down the chute (not shown) of bowl cover 50′, the supply circuit remains open and the motor cannot start.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A magnetic switch in combination with a food processor comprising a base, an electric motor enclosed by the base, an electric control circuit for the motor, a bowl removably locked on the base, and a bowl cover removably locked on the bowl, the magnetic switch comprising
magnets secured in a top part of a tower extending from the base;
magnets secured to the bowl cover, such that when the bowl cover is locked on the bowl and the bowl is properly positioned on the base, the magnets in the cover are in alignment with the magnets in the tower; and
a contact mounted inside the base and connected to the electric control circuit.

2. A magnetic switch in combination with a food processor comprising a base, an electric motor enclosed by the base, an electric control circuit for the motor, a bowl removably locked on the base, a bowl cover removably locked on the bowl, the cover including a chute, and a pusher for pressing inserted products into the chute, the magnetic switch comprising
magnets secured in a top part of a tower extending from the base;
magnets secured to the bowl cover, such that when the bowl cover is locked on the bowl and the bowl is properly positioned on the base, the magnets in the cover are in alignment with the magnets in the tower;
a contact connected with the electric control circuit for the motor, wherein the contact is closed when the pusher is fully inserted into the chute.

3. The magnetic switch of claim 2 comprising four magnets in the tower arranged in alternating magnetic polarities.

4. The magnetic switch of claim 3 comprising four magnets in the bowl cover,
wherein the arrangement of the polarity of the magnets in the bowl cover is the same as the arrangement of the polarity of the magnets in the tower so as to produce repulsion of the magnets in the tower when the pusher is fully inserted into the chute.

5. A magnetic switch in combination with a food processor comprising a base, an electric motor enclosed by the base, an electric control circuit for the motor, a bowl removably locked on the base, a bowl cover removably locked on the bowl, the cover including a chute, and a pusher for pressing inserted products into the chute, the magnetic switch comprising
magnets secured in a top part of a tower extending from the base;
magnets secured to the bowl cover, such that when the bowl cover is locked on the bowl and the bowl is properly positioned on the base, the magnets in the cover are in alignment with magnets in the tower;
magnets secured in the pusher, such that when the bowl cover is locked on the bowl, the bowl is properly positioned on the base, and the pusher is pressed down a chute of the bowl cover, the magnets in the pusher are in alignment with magnets in the tower;
a contact connected with the electric control circuit for the motor, wherein the contact is closed when the pusher is fully inserted into the chute.

6. The magnetic switch of claim 5 comprising four magnets in the tower arranged in alternating magnetic polarities.

7. The magnetic switch of claim 6 comprising two magnets in the bowl cover,
wherein the arrangement of the polarity of the magnets in the bowl cover is the same as the arrangement of the polarity of at least two of the magnets in the tower so as to produce repulsion of the magnets in the tower when the pusher is fully inserted into the chute.

8. The magnetic switch of claim 7 comprising two magnets in the pusher,
wherein the arrangement of the polarity of the magnets in the pusher is the same as the arrangement of the polarity of at least two of the magnets in the tower so as to produce repulsion of the magnets in the tower when the pusher is fully inserted into the chute.
